(19) United States
(12) Patent Application Publication
(10) Pub. No.: US 2015/0315931 A1
(43) Pub. Date: Nov. 5, 2015

(54) DEVICE FOR CONNECTING A FIXED PORTION OF A TURBINE ENGINE AND A DISTRIBUTOR FOOT OF A TURBINE ENGINE TURBINE

(71) Applicant: SNECMA, Paris (FR)

(72) Inventors: Fabien GARNIER, Moissy-Cramayel Cedex (FR); Sebastien PRESTEL, Moissy-Cramayel Cedex (FR); Helene CONDAT, Moissy-Cramayel Cedex (FR); Patrice ROSSET, Moissy-Cramayel Cedex (FR); Arnaud GENILIER, Moissy-Cramayel Cedex (FR)

(73) Assignee: SNECMA, Paris (FR)

(21) Appl. No.: 14/503,743

(22) Filed: Oct. 1, 2014

(30) Foreign Application Priority Data
Oct. 1, 2013 (FR) 13 59495

(51) Int. Cl. F01D 25/14

(52) U.S. Cl. CPC F01D 25/145; F05D 2220/30; F05D 2260/231

(57) ABSTRACT

A device (1) for connecting a fixed turbine engine portion (2) and a distributor (3) foot (31) of a turbine engine turbine, comprising a ring-shaped flange (111), the flange (111) being adapted so as to be connected and secured to the fixed turbine engine portion (2) and to the foot (31) of the distributor, the device being characterized in that it further comprises a ring-shaped screen (9), the screen (9) being connected and secured to the flange (111) so as to be positioned in an upstream chamber (4) made between the fixed turbine engine portion (2) and the flange (111) so as to at least partly block heat radiation from the fixed turbine engine portion (2) and directed towards the flange (111).

### TECHNICAL FIELD

It relates to the technical field of aircraft turbine engines. In particular it relates to the field of devices adapted for connecting a distributor foot and a fixed turbine engine portion.

### STATE OF THE ART

Devices for connecting a fixed turbine engine portion, such as an inter-turbine casing 2 and a distributor foot of a turbine engine turbine, for example a turbine engine low temperature turbine, are known.

Such devices comprise one or several parts having the shape of a ring so as to extend to 360° around a turbine engine shaft.

Such devices typically comprise a ring-shaped flange 111 adapted so as to be connected and secured to the fixed portion of a turbine engine.

The flange 111 is adapted so as to be connected to the foot 31 of the distributor 3.

FIGS. 1 and 2 illustrate an example of such a device.

Such a device allows inter alia isolation of the upstream 4 and downstream 5 chambers from each other, the upstream 4 and downstream 5 chambers being positioned upstream and downstream from the distributor foot 31, respectively.

However, during normal operation of the turbine engine, the upstream side of the device is subject to significant heat radiation from the fixed turbine engine portion, for example from the inter-turbine casing 2.

The portions of the device exposed to such radiations may attain high temperatures, typically between 700° C. and 900° C.

In particular, the flange ill of the device 1 then attains high temperatures and tends to expand, extend.

The result of this is stresses tending to unwind the flange 111 downstream, typically in the direction and in the sense of the arrow 501. This causes a tilting or unwinding torque of the whole of the device 1 downstream.

However, the presence of the foot 31 of the distributor prevents unwinding of the device. The foot 31 of the distributor is then subject to the corresponding forces.

As illustrated in FIG. 2, the distributor is blocked at the head by hooks of the casing of the turbine engine opposing these forces, typically by exerting forces in the direction and in the sense of the arrows 502. The distributor 3 is therefore subject to stresses which reduce its lifetime and risk causing its failure.

Further, these stresses result from heat transfers in an area of reduced size. Thus, the stresses may strongly vary depending on the conditions to which is subject the flange 111 and are difficult to predict.

### PRESENTATION

An object of the invention is to increase the lifetime of the distributor.

For this purpose, a device is provided for connecting a fixed turbine engine portion and a distributor foot of a turbine engine turbine, comprising a ring-shaped flange, the flange being adapted so as to be connected and secured to the fixed turbine engine portion and to the distributor foot, the device further comprising a ring-shaped screen, the screen being connected and secured to the flange so as to be positioned in an upstream chamber made between the fixed turbine engine portion and the flange in order to at least partly block heat radiation from the fixed turbine engine portion and directed towards the flange.

The presence of the screen according to the invention gives the possibility of limiting the rise in temperature of the flange by at least partly blocking heat radiation from the inter-turbine casing and directed towards the flange. The result of this is a substantial reduction in the extent of the tilting torque of the device downstream, or even its disappearance. The tilting forces exerted on the foot of the distributor by the device are then reduced, reducing by as much the wear of the distributor and the risks of failure of the distributor at a stressed area.

It is thus possible to reduce the stresses to which the distributor is subject.

Another advantage is to increase the robustness of the system, notably from a thermal point of view.

The invention is advantageously completed by the following features, taken alone or in any of their technically possible combinations:
the screen is further adapted for preventing contact of a fluid with the flange, the fluid stemming from a vein of the turbine engine and being able to penetrate into the chamber, so as to limit a transfer of heat by convection and/or conduction of the vein fluid towards the flange,
the screen comprises an inner edge and an outer edge and the inner edge is positioned upstream from the outer edge,
the screen comprises a first portion extending from the inner edge, so as to at least partly block the thermal radiation from the fixed turbine engine portion and directed towards the flange, and a second portion extending from the outer edge, the outer edge being free, in order to limit the introduction, between the screen and the flange downstream from the first portion, of a fluid from a vein of the turbine engine, the second portion being connected to the first portion by a fold,
the screen is further adapted for orienting a flow for purging the upstream chamber along the screen, so as to cool the screen,
the screen comprises a first portion, the profile of which follows the shape of the fixed turbine engine portion facing the flange.
the screen comprises an inner edge and an outer edge, the screen being attached to the flange by attachment means positioned at one of the edges, the other edge being free,
the screen is attached to the flange at a secured connection between the flange and the fixed turbine engine portion,
the means for attaching the screen to the flange comprise at least one elastic element laid out in order to at least partly absorb stresses associated with the expansion of the screen,
the screen is folded at its free end so as to exhibit a fold adapted for stiffening the screen.

The invention further relates to a turbine engine turbine comprising a device as described earlier.

The invention further relates to a turbine engine comprising a device as described earlier.

### DRAWINGS

Other objects, features and advantages will become apparent upon reading the description which follows, given as an illustration and not as a limitation with reference to the drawings, wherein:

FIG. 1 illustrates a sectional view of a device according to the prior art,

FIG. 2 illustrates the forces applied to a turbine distributor, connected to a device according to the prior art,

FIG. 3 illustrates a sectional view of a device according to an exemplary embodiment of the invention,

FIG. 4 illustrates a sectional view of means for attaching a device according to the invention, in accordance with an exemplary embodiment of the invention,

FIG. 5 illustrates a sectional view of means for attaching a device according to the invention, in accordance with another exemplary embodiment of the invention.

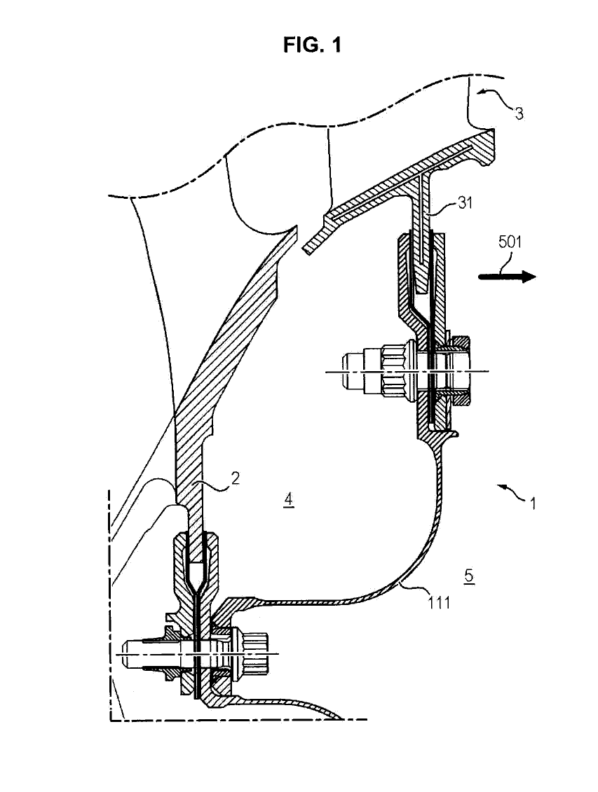

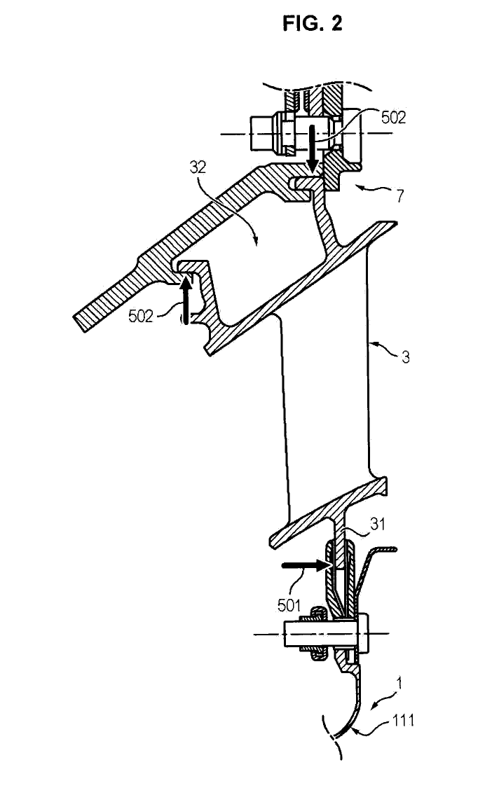

### DESCRIPTION

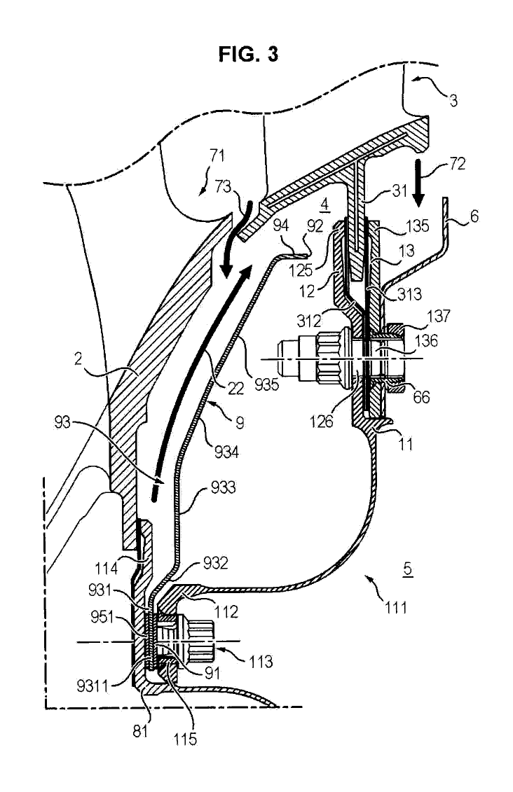

With reference to FIG. 3, a device 1 is described for connecting a fixed turbine engine portion and a distributor 3 foot 31 of a turbine engine turbine according to an exemplary embodiment.

### Turbine Engine

General Structure

The turbine engine is for example a turbine engine of the type with a cowled fan or with a non-cowled fan (open rotor or unducted fan) of an aircraft.

The turbine engine is typically organized along an axis a so-called turbine engine axis.

Conventionally, an air flow which penetrates into the turbine engine at an air intake is compressed and then mixed with fuel and burnt in a combustion chamber, the combustion gases giving the possibility of driving into rotation a rotor or several turbine rotors around an axis of the turbine engine.

The turbine engine for example comprises a high pressure turbine giving a possibility of driving a high pressure compressor, and a low pressure turbine giving the possibility of driving a low pressure compressor and a fan.

Elements are described here as inner or central and outer or peripheral elements depending on their relative distance to an axis (not shown) of the turbine engine on which the device is intended to be installed, when the device 1 is in an operating position.

Also, by “above” is meant a position at a relatively larger distance from the shaft of the turbine engine, and by “below” is meant a position at a relatively small distance from the shaft of the turbine engine when the device 1 is in an operating position.

An element relatively closer to a shaft of the turbine engine is thus described as an inner element. Also, an element relatively more distant from the shaft of the turbine engine is described as an outer element.

Thus, in a given element, a portion described as inner or central is typically positioned at a relatively smaller distance from the axis of the turbine engine than a portion described as outer or peripheral when the device 1 is in an operating position.

Elements depending on their relative position along the axis of the turbine engine are described here as upstream and downstream elements.

Thus an element relatively closer to an air intake of the turbine engine or farther away from an air outlet of the turbine engine, typically from a nozzle, is thus described as an upstream element. Also, an element relatively farther away from the air intake of the turbine engine or closer to the air outlet of the turbine engine is described here as a downstream element.

Typically, the terms of upstream and downstream relate to the general direction of circulation of the air, in the turbine engine between its inlet and its outlet.

Elements are described as being axial, respectively radial, relatively to an axial, respectively radial, direction of the turbine engine.

The connecting device is typically positioned at a turbine. The connecting device is for example positioned at the inlet of the turbine, at the connection between the fixed turbine engine portion and the turbine, for example, at the inlet of the low pressure turbine downstream from the high pressure turbine, for example at the connection between the inter-turbine casing 2, and the low pressure turbine.

Fixed Turbine Engine Portion

The fixed turbine engine portion is distinct from the foot 31 of a distributor 3. The fixed turbine engine portion is for example a casing, for example an inter-turbine casing 2.

The inter-turbine casing 2 is typically an intermediate casing between two portions of the turbine engine. The inter-turbine casing 2 may be interposed between the high pressure and low pressure turbines accommodated in their respective casings.

The inter-turbine casing 2 for example comprises inner and outer walls defining a vein 71 for circulation of the flow between the high pressure and low pressure turbines, and arms extending between the inner and outer walls.

In the case of a ducted fan turbine engine of an aircraft, the turbine engine includes typically a primary vein for flow of the gases and a secondary vein 71 for flow of the gases, separated by an inter-vein compartment at the inter-turbine casing 2.

The turbine typically comprises a plurality of stages, each with a distributor receiving a gas flow and rectifying it in order to apply it on a mobile wheel rotating in a given direction. The turbine is typically a low pressure turbine.

Distributor

The distributor 3 is for example a low pressure distributor 3, positioned at the inlet of the low pressure turbine, i.e. the upstream distributor of the low pressure turbine, typically positioned downstream from a rectifier for the fluid of the high pressure turbine, for example directly downstream from the rectifier, or downstream from a wheel itself positioned downstream from the rectifier. Alternatively, the distributor may be positioned downstream from the low pressure turbine, or at another turbine.

The distributor 3 comprises a head and a foot 31 maintained fixed in the turbine engine. The distributor 3 is positioned in a substantially radial way, the foot 31 being turned towards the inside and the head towards the outside.

The head is typically attached with hooks of a casing of the turbine engine.

The foot 31 is connected to the connecting device, for example by means of brackets which will clamp the foot 31.

### Ring-Shaped Flange

General Structure

The device comprises a flange 111.

The flange 111 is ring-shaped, i.e. it has the shape of a ring.

The flange 111 is adapted so as to be connected and secured to the fixed turbine engine portion, typically to the inter-turbine casing 2.

By a secured connection between two elements, is typically meant that the connection is such that a movement of one of the elements according to a degree of freedom involves the same movement of the other element according to the same degree of freedom. The secured connection is for example an attachment.

This connection ensures the maintaining of the foot 31 of the distributor.

This connection may also give the possibility of separating the upstream side and the downstream side of an area under the foot 31 of the distributor when the device 1 is positioned in a turbine engine.

The flange 111 is typically adapted for separating the upstream side and the downstream side of an area under the foot 31 of the distributor when the device is positioned in the turbine engine.

The flange 111 is for example connected to the inter-turbine casing 2 so that the device 1 prevents any fluid circulation under the foot 31 of the distributor, typically in an area extending under the foot 31 of the distributor.

For example, it is possible to prevent any circulation of fluid between upstream 4 and downstream 5 chambers positioned upstream and downstream from the distributor foot 31 respectively.

The flange 111 is adapted so as to be connected to the foot 31 of the distributor 3. For this purpose, the device for example comprises two brackets. The brackets are for example connected and secured to the flange. The brackets are for example adapted so as to clamp the foot 31 of the distributor 3.

Secured Connection to the Fixed Turbine Engine Portion

The secured connection of the flange 111 to the fixed turbine engine portion, typically to the inner-turbine casing 2 may be made by any means known to one skilled in the art.

The connection may thus be made by welding (not shown).

Alternatively, the flange 111 may have at least one attachment bracket 112. Such an attachment bracket 112 typically has an orifice through which an attachment element 113 may be inserted, typically an element of the screw-nut type, typically an element of the bolt type, as illustrated.

The attachment element 113 may be adapted for crossing an orifice of the fixed turbine engine portion, typically of the inter-turbine casing 2, or of an intermediate connecting element 114 for example comprising dedicated brackets which will clamp a wall of the fixed turbine engine portion, typically of the inter-turbine casing 2. Such an intermediate connecting element 114 may be included into the device 1 or form a separate element of the device 1.

It is understood that such a layout may be reproduced several times along the ring-shaped structure of the flange 111 so as to ensure better attachment.

### Ring-Shaped Screen

General Structure

The device comprises a ring-shaped screen 9. By ring-shaped screen, is meant a screen having the shape of a ring.

By shape of a ring, is meant a shape extending substantially around a given axis, the shape being located in an area comprised between a first central axisymmetrical cylinder centered on the axis and having a first radius and a second peripheral axisymmetrical cylinder centered on the axis and having a second radius larger than the first radius.

In other words, the ring-shape substantially extends around the axis, while remaining at a minimum distance from the axis, like a ring.

A ring shape thus typically comprises a shape having a substantially rounded outer contour and having a central orifice.

The ring shape may be continuous, i.e. its projections in planes orthogonal to the axis comprise a closed loop positioned around the axis.

The ring shape may be interrupted, i.e. its projections on planes orthogonal to the axis comprise a loop having at least one interruption, i.e. one or a plurality of interruptions.

The interruption may interrupt the shape right through, like a C, or only partly, i.e. a closed loop surrounds the axis, the closed loop being in at least a substantially thinner area than the remainder of the shape.

The screen 9 is connected and secured to the flange 111.

The secured connection of the screen 9 to the flange ill is made so that the screen 9 is positioned in an upstream chamber 4 made between the inter-turbine casing 2 and the flange 111.

The screen 9 is thus positioned for at least partly blocking heat radiation from the inter-turbine casing 2 and directed towards the flange 111.

During normal operation of the turbine engine, the upstream side of the device 1 is subject to significant heat radiation from the inter-turbine casing 2.

In the devices according to the prior art, the flange 111 of the device exposed to such radiations attains high temperatures when the turbine engine is operating, the temperatures may typically be of the order of 700° C. to 900° C.

In particular, in these devices according to the prior art, the flange 111 of the device 1, then attaining high temperatures, tends to expand, to extend. The result of this is stresses tending to unwind the flange 111 downstream. This causes a tilting or unwinding torque of the whole of the device 1 downstream.

Now, relatively to the prior art, the presence of the screen 9 according to the invention gives the possibility of limiting the rise in temperature of the flange 111, by at least partly blocking heat radiation from the inter-turbine casing 2 and directed towards the flange 111.

The result of this is a substantial reduction in the extent of the tilting torque of the device 1 downstream, or even its disappearance.

Indeed, in the case of the device according to the invention, the stresses are strongly reduced as compared with the device according to the prior art, since the temperature of the flange 111 during operation of the turbine engine is strongly reduced because of less heat transfer and the expansion phenomenon of the flange 111 is strongly reduced.

Thus, the tilting forces exerted on the foot 31 of the distributor by the device 1 are then reduced, reducing by as much the wear of the distributor 3 and the risks of failure of the distributor 3 at a stress area 32.

The screen 9 further allows reduction in the fatigue of the distributor 3 resulting from the fact that the foot 31 is subject to periodic stresses between the passing of the turbine engine from a non-operating condition to a normal operating condition and between the passing of the turbine engine from a normal operating condition to a non-operating condition.

Thus, in addition to globally reducing the forces exerted on the foot of the distributor 3, the invention gives the possibility of reducing the fatigue phenomenon caused by periodic repetition of forces exerted on the foot 31 of the distributor, a phenomenon which may further increase the risks of failure of a distributor 3, the foot 31 of which is clamped by a device according to the prior art relatively to a constant force.

Screen Towards a Turbine Engine Vein Fluid

Preferentially, the screen 9 is further adapted so as to prevent contact of a fluid with the flange 111, the fluid coming from a vein 71 of the turbine engine in the form of a vein fluid flow 73, the fluid being able to penetrate into the chamber 4.

The screen 9 is thus adapted for limiting heat transfer by convection and/or conduction from the vein fluid to the flange 111.

As illustrated in FIG. 3, the chamber 4 is typically fluidically connected to the vein 71 located above the upstream chamber 4 and the flange 111 in the turbine engine. This fluid is thus an output fluid of the high pressure turbine and it is therefore at a high temperature, typically of the order of 800° C. to 1,100° C.

During the operation of the turbine engine, the upstream side of the device 1 is subject to possible returns of high temperature vein fluid.

The arrival of fluid from this vein 71 may be limited by introducing into the chamber a colder purge flow 22 and thus maintain sufficient pressure in the chamber for avoiding introduction of fluid from the vein 71.

This purge flow 22 typically comes from the high pressure compressor.

However, during the operation of the turbine engine, this purge flow 22 may be reduced and/or the pressure of the vein fluid 71 may be increased, so that a vein fluid flow 73 penetrates into the chamber 4.

In the prior art, the vein fluid flow 73 thus participates, by heat transfer phenomena by conduction and convection, in the rise in temperature of the flange 111 and therefore in its expansion, in its extension.

The result of this is additional stresses tending to unwind the flange 111 downstream. This causes a tilting or unwinding torque of the whole of the device 1 downstream further increased relatively to the one which would be only caused by the radiation of the inter-turbine casing 2 and subsequent to even more rapid wear of the distributor 3.

Further, the vein fluid flow 73 may to some extent damage the device, in particular the flange 111, and therefore put the upstream chamber 4 and the downstream chamber 5 in fluidic communication while the flange 111 should generally ensure a sealed separation of both of these chambers.

Now, unlike the prior art, the presence of the screen 9 may also give the possibility of limiting the rise in temperature of the flange 111 by limiting or by at least partly blocking, heat transfer through convection and/or conduction from the vein fluid to the flange 111.

The result of this is an even more substantial reduction of the extent of the tilting torque of the device 1 downstream, or even its disappearance.

Thus, the tilting forces exerted on the foot 31 of the distributor by the device 1 are then even further reduced, reducing by as much the wear of the distributor 3 and the risks of failure of the distributor 3 at a stress area 32.

Also, it is thus possible to further reduce the fatigue of the distributor 3, i.e. the wear due to the periodic succession of stresses between the passing of the turbine engine from a non-operating condition to a normal operating condition and between the passing of the turbine engine from a normal operating condition to a non-operating condition.

Thus, in addition to globally reducing the forces exerted on the foot 31 of the distributor 3, the invention may give the possibility of further reducing the fatigue phenomenon of the distributor 3 caused by the periodic repetition of forces exerted on the foot 31 of the distributor.

Secured Connection to the Flange

As indicated earlier, the secured connection of the screen 9 to the flange 111 is achieved so that the screen 9 is positioned in an upstream chamber 4 made between the inter-turbine casing 2 and the flange 111.

The screen 9 is for example attached to the flange 111 at a secured connection between the flange 111 and the inter-turbine casing 2.

The connection is for example ensured by means for attaching the screen to the flange 111.

The secured connection of the flange 111 to the inter-turbine casing 2 may be made by any means known to one skilled in the art.

The secured connection may thus be made by welding (not shown). This embodiment is particularly preferred when the screen 9 is in a metal sheet.

Alternatively, the screen 9 may have at least one attachment bracket 931.

Such an attachment bracket 931 typically has an orifice 9311 through which an attachment element 113 may be inserted, typically an element of the bolt type, as illustrated, typically an element of the screw-nut type.

The attachment element 113 may be adapted for crossing an orifice of the flange 111 or an orifice of an intermediate connecting element comprising for example dedicated brackets which will clamp a wall of the flange 111.

One or several of the orifices allowing connection may be provided with one or several bushings 115. The bushing(s) 115 give(s) the possibility of facilitating the extraction of the flange 111.

It is understood that such a layout may be reproduced several times along the ring-shaped structure of the screen 9 so as to ensure better attachment.

Preferentially, the means for attaching the screen 9 to the flange 111 comprise at least one elastic element laid out for absorbing at least partly the stresses associated with an expansion of the screen 9.

The elastic element gives the possibility of reducing the stresses applied to the screen 9 during its expansion due to the increase of its internal temperature, and therefore reducing the wear of the screen 9 at its attachment secured to the flange 111.

The elastic element further gives the possibility of avoiding deterioration of the screen 9 upon tightening the attachment with the flange 111. Additionally or alternatively, the elastic element further allows better strength of the screen 9, in particular by better flattening of the screen against the flange 111 or against the inter-turbine casing 2 at its attachment.

The elastic element for example has a ring shape so as to protect the entirety of a ring-shaped attachment area of the screen 9. Alternatively, several elastic elements may be positioned along the ring-shaped attachment area of the screen 9.

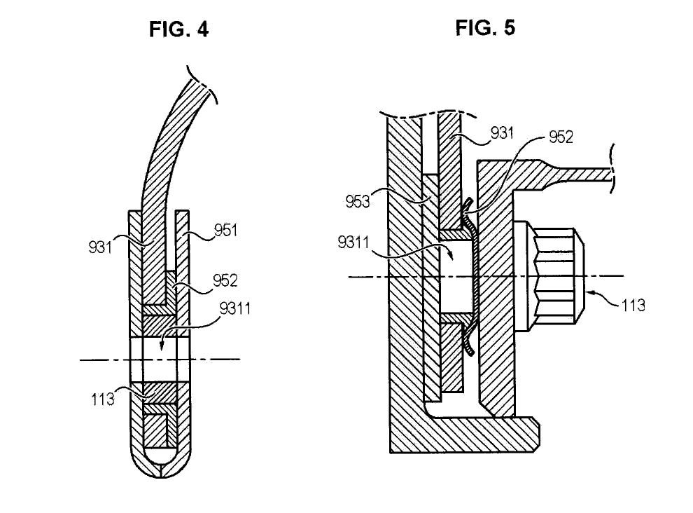

Said at least one elastic element for example comprises a first elastic element 951 having a U-shaped section inside which an end of the screen 9 will be accommodated. This embodiment is illustrated in FIGS. 3 and 4. This embodiment is particularly preferred when the screen 9 is made in a brittle material, typically a composite material, typically a composite with a ceramic matrix.

Alternatively or additionally, said at least one elastic element for example comprises a second elastic element 952, typically ring-shaped, forming a spring positioned between the flange 111 and the screen 9. This embodiment is illustrated in FIG. 6.

As illustrated in FIG. 3, the first elastic element 951 may form a protective element. As illustrated in FIG. 5, the elastic element 952 may be distinct from a protective element 953 positioned elsewhere on the screen 9.

### Structure Example

With reference to FIG. 3, a structure example is described.

The screen 9 may comprise several portions.

The screen 9 may comprise a first portion 93, the profile of which follows the shape of the inter-turbine casing 2 facing the flange 111.

This first portion thus has a profile efficiently blocking heat radiation from the inter-turbine casing 2.

This first portion 93 thus has a profile also adapted so as to prevent a contact of the fluid from the vein 71 with the flange 111.

The screen 9 may be attached to the flange 111 by attachment means positioned at one of its edges, an inner edge 91 or an outer edge 92, the other edge being free.

Thus, the attachment means may be provided at a first sub-portion 931 of the first portion, this first sub-portion being located at an edge of the screen, typically the inner edge 91.

With reference to FIG. 3, the first portion 93 may comprise a succession of sub-portions according to the shape of the inter-turbine casing 2. Each sub-portion may be located downstream from the previous ones so as to protect the flange 111.

The sub-portions preferably have a straight profile. The sub-portions are preferably connected to each other through folds. It is thus possible to facilitate the making of the screen 9.

In particular, the first portion 93 may thus comprise a second sub-portion 932 directly connected through a first end to the first sub-portion 931 by a fold. Also, the first portion 93 may comprise a third portion 933, a fourth portion 934 and a fifth portion 935, each being connected at a first end to a second end of the previous one by a fold.

The screen may be made in metal sheet.

The screen 9 is preferentially made in a material having a low heat exchange coefficient, typically lower than that of the flange 111. It is thus possible to limit the transmission of the heat stored by the screen 9, typically its transmission to the flange 111, by conduction or convection or radiation, notably via a fluid present in the screen 9 and the flange 111, or by conduction at a secured connection between the screen 9 and the flange 111.

The screen 9 is typically made in a composite material, in ceramic or comprising a ceramic, typically of the composite type with a ceramic matrix, or in another material having low heat conductivity known to one skilled in the art, typically in another refractory material.

Orientation of a Purge Flow

According to an exemplary embodiment, illustrated in FIG. 3, the screen 9 may further be adapted for orienting a purge flow 22 for the upstream chamber 4 along the screen 9, so as to cool the screen 9.

Indeed, as explained earlier, a purge flow 22 may be introduced into the upstream chamber 4 so as to thereby maintain sufficient pressure in the chamber for avoiding the introduction of fluid from the vein 71.

This purge flow 22 is typically colder than the vein flow 73. This purge flow 22 typically comes from a high pressure compressor of the turbine engine.

The purge flow 22 typically has a temperature of the order of a few hundred degrees Celsius, typically a temperature of the order of 300° C. or 400° C., preferentially a temperature comprised between 300° C. and 400° C.

Thus, the purge flow 22, flowing along the screen 9, allows cooling of the screen 9 by heat conduction and/or convection. This cooling gives the possibility of limiting the increase in temperature of the screen 9 as for it due to the heat radiation from the inter-turbine casing 2, and also possibly due to the hot fluid from the vein 71.

On the one hand this allows an extension of the lifetime of the screen 9 by reducing the temperature to which it is brought.

Further, this allows limitation of the heat transfers between the screen 9 and the flange 111, in particular radiation transfer for which the intensity increases with temperature.

Further this allows a reduction in the cost for making such a device by producing a screen dimensioned in order to support lower temperatures.

The purge flow 22 is typically introduced from the upstream side of the upstream chamber 4 preferably in a lower portion of the upstream chamber 4.

The purge flow 22 then flows along the surface of the screen 9 towards the vein 71.

It is thus possible to ensure that a large surface area of the screen 9 is cooled by the purge flow 22, in particular when the inner edge 91 of the screen 9 is located upstream from the outer edge 92, as illustrated in FIG. 3.

The purge flow 22 is typically introduced by fluidic flow means 21 for a purge flow 22 provided at the inter-turbine casing 2.

The fluidic flow means 21 for example comprise an orifice, typically a plurality of flow orifices (not shown) positioned at a wall of the inter-turbine casing 2.

The fluidic flow means are preferentially positioned at the secured connection of the flange 111 to the screen 9, which is typically found at the same level as the secured connection of the flange 111 to the inter-turbine casing 2.

It is thus possible to maximize the surface area of the screen 9 cooled by the purge flow 22 when the inner edge of the screen 9 is positioned upstream from the outer edge, as illustrated in FIG. 3.

Fold

According to a particular embodiment, illustrated in FIG. 3, the screen 9 comprises an inner edge 91 and an outer edge 92 and the inner edge 91 is positioned upstream from the outer edge 92.

In particular, the screen may comprise a first portion 93 extending from the inner edge 91, in order to at least partly block heat radiation from the inter-turbine casing 2 and directed towards the flange 111.

The first portion 93 may correspond to the exemplary embodiments described earlier.

The screen may further comprise a second portion 94.

The second portion 94 typically extends from the outer edge 92, the outer edge being free.

The second portion may be laid out and adapted so as to limit the introduction, between the screen 9 and the flange 111 downstream from the first portion 93, of the fluid of the veins 71 of the turbine engine, the second portion 94 being connected to the first portion 93 through a fold.

It is thus possible to improve the structure of the screen 9 so as to better further block any vein flow 73 directed towards the flange 111, while retaining an end of the flange 111 free.

It is advantageous to leave a free end since in this way the screen 9 does not impose any constraint to the remainder of the device and to the foot of the distributor if it happens to deform under the effect of a change of its temperature.

Further, the screen 9 is not itself subject to the same stresses as if it was attached at its two ends 91 and 92. Indeed, the stresses resulting from attachments to both ends 91 and 92 may cause deterioration or even failure of the actual screen 9.

The screen 9 is therefore easier to make since such limitations do not have to be taken into account during its dimensioning.

According to a particular embodiment, illustrated in FIG. 3, the second portion 94 of the screen 9 is connected to a second end of the fifth sub-portion 935 of the first portion 93.

Alternatively or additionally to this embodiment, the screen 9 is folded at its free end so as to exhibit a fold adapted for stiffening the screen 9.

The screen 9 may be made according to the embodiment comprising a first portion 93 and a second portion 94, in which case the fold for stiffening the screen 9 is preferentially the same as the fold connecting the first portion 93 and the second portion 94.

### Bracket

General Structure

According to an exemplary embodiment, the device may comprise two brackets, an upstream bracket 12 and a downstream bracket 13.

The brackets 12 and 13 are preferentially ring-shaped brackets, i.e. they each have a ring shape.

By ring-shaped bracket is generally meant an attachment part with a ring shape, i.e. pierced in its center, and typically having orifices at its periphery for allowing attachment to another element, typically another element forming a bracket.

Secured Connection to the Flange

The brackets 12 and 13 are for example each secured to the flange 111.

The connection of a bracket 12 or 13 to the flange 111 may be a direct connection to the flange or via an intermediate portion, and/or via the other bracket.

The secured connection may thus be made by welding or the flange 111 and the bracket 12 or 13 may be made so as to form only a single part.

Alternatively or additionally, the bracket 12 or 13 may be mounted secured to the flange 111.

According to an example, the bracket 12 or 13 may comprise at least one attachment orifice 136. Such an attachment orifice 136 may be laid out so that an attachment element 137 may be inserted through it, typically an element of the bolt type, as illustrated, or an element of the screw-nut type (not shown).

The attachment element 137 may be adapted for crossing an orifice of the flange 111 and/or of an intermediate connecting element, typically the other bracket.

It is understood that such a layout may be reproduced several times along the ring-shaped structure of the bracket so as to ensure better attachment.

With reference to FIG. 3, one of the brackets, typically the upstream bracket 12 may be connected and secured by welding to the flange 111 along a ring-shaped connection area. The other bracket, typically the downstream bracket 13, may be mounted secured on the upstream bracket 12 by means of attachment elements 137 crossing the aligned orifices of both brackets 12 and 13, each bracket 12 and 13 having a plurality of orifices distributed along their ring-shaped structure.

Connection to the Foot of the Distributor

Both brackets 12 and 13 are for example adapted so as to clamp the foot 31 of the distributor. Both brackets 12 and 13 thereby form a clamp.

Both brackets 12 and 13 thus come into contact with the foot 31 of the distributor, on either side of the distributor, in order to maintain it in position in the turbine engine.

The brackets 12 and 13 thus allow connection of the body 11 and of the foot 31 of the distributor, for example through a connection secured in translation along the axis of the turbine engine, preferably also secured in rotation along an axis orthogonal to the axis of the turbine engine, preferably secured in rotation regardless of the axis.

Preferably, the connection is secured in rotation and secured in translation except along the radial axis, i.e. the only authorized relative movement is translation along the axis orthogonal to the axis of the turbine engine oriented in the same direction as the foot 31.

The connection may alternatively be a connection secured in translation and in rotation.

Both brackets 12 and 13 will typically come into contact with the foot 31 of the distributor at respective ends 125 and 135.

For this purpose, the brackets 12 and 13 are typically laid out so that the ends 125 and 135 of both brackets 12 and 13 are separated by a space, this space forming a space for receiving the foot 31 of the distributor.

The size of the space may typically be adjusted, for example by means for connecting one bracket 13 to the other 12, for example the connection means 136 and 137 described earlier.

In order to obtain a sealed contact area, it is possible to position a sealing element comprising one or several sealing parts, for example, one or several sealing plates or platelets, typically sealing metal sheets 312 and 313, between each bracket 12 and 13 and the foot 31 of the distributor. Between said at least one of the brackets 12 and/or 13 and the foot 31, the sealing element may thus be formed with a plurality of distinct sealing parts distributed along the area positioned between the bracket and the foot 31, the damping parts being separated from each other so as to form interruptions of the sealing element.

Scalloping

The upstream 12 and/or downstream 13 bracket may have scalloping, typically between attachment orifices, typically between an attachment orifice 126 of the upstream bracket 12 and the attachment orifice 136 of the downstream bracket 13.

By scalloping, is meant that the orifices are placed between notches giving the ring-shaped upstream bracket 12 and/or downstream bracket 13 a “scallop shape, or in other words, a crenellated shape with typically rounded edges.

### Downstream Overlapping Metal Sheet

General Structure

The device 1 may further comprise a ring-shaped downstream overlapping metal sheet 6 secured to the flange 111.

The downstream overlapping metal sheet 6 is positioned downstream from the flange 111, for example positioned downstream from the brackets 12 and 13 when the device comprises such brackets, so as to limit heating-up of a downstream chamber 5 positioned under and downstream from the foot 31 of the distributor, by a flow of a fluid 72 from a vein located above the downstream chamber 5.

Secured Connection to the Flange

The downstream overlapping metal sheet 6 is typically made so as to be secured to the flange 111 in a similar way to the brackets 12 and 13.

The connection of the downstream overlapping metal sheet 6 to the flange 111 may be a direct connection to the flange or via an intermediate portion, and/or via a bracket 12 and/or 13.

The secured connection may thus be made by welding or the flange 111 and the downstream overlapping metal sheet 6 may be made so as to only form a single part.

According to an example, the discourager joint 6 may comprise at least one attachment orifice 66. Such an attachment orifice 66 may be laid out so that an attachment element 137 may be inserted through it, typically an element of the bolt type, as illustrated, or an element of the screw-nut type (not shown).

The attachment element 137 may be adapted so as to cross an orifice of the flange 111 and/or of an intermediate connecting element, typically the upstream bracket 12 and/or the downstream bracket 13.

According to an example, the downstream overlapping metal sheet 6 may comprise at least one attachment orifice. Such an attachment orifice may be laid out so that an attachment element may be inserted through it, typically an element of the bolt type, as illustrated, or an element of the screw-nut type.

The attachment element may be adapted for crossing an orifice of the flange 111 and/or of an intermediate connecting element, typically the upstream bracket 12 and/or the downstream bracket 13.

It is understood that such a layout may be reproduced several times along the ring-shaped structure of the bracket so as to ensure better attachment.

With reference to FIG. 3, one of the brackets, typically the upstream bracket 12, may be connected and secured by welding to the flange 111 along a ring-shaped connecting area. The downstream overlapping metal sheet 6 may be mounted and secured on the upstream bracket 12 by means of attachment elements 137 crossing aligned orifices of the upstream bracket 12 of the downstream overlapping metal sheet 6, each having a plurality of orifices distributed along their ring-shaped structure.

1. A device for connecting a fixed turbine engine portion and a distributor foot of a turbine engine turbine, comprising:
a ring-shaped flange, the flange being adapted so as to be connected and secured to the fixed turbine engine portion, and
two brackets secured to the flange adapted for clamping the foot of the distributor,
the device including a ring-shaped screen, the screen being connected and secured to the flange so as to be positioned in an upstream chamber made between the fixed turbine engine portion and the flange for at least partly blocking heat radiation from the fixed turbine engine portion and directed towards the flange.

2. The device according to claim 1, wherein the screen is further adapted so as to prevent contact of a fluid with the flange, the fluid stemming from a vein of the turbine engine and being able to penetrate into the chamber, so as to limit heat transfer by convection and/or conduction from the vein fluid towards the flange.

3. The device according to claim 1, wherein the screen comprises an inner edge and an outer edge and the inner edge is positioned upstream from the outer edge.

4. The device according to claim 3, wherein the screen comprises a first portion extending from the inner edge, for at least blocking partly the heat radiation from the fixed turbine engine portion and directed towards the flange, and a second portion extending from the outer edge, the outer edge being free, in order to limit the introduction, between the screen and the flange downstream from the first portion, of a fluid from a vein of the turbine engine, the second portion being connected to the first portion by a fold.

5. The device according to claim 1, wherein the screen is further adapted so as to orient a flow for purging the upstream chamber along the screen, so as to cool the screen.

6. The device according to claim 1, wherein the screen comprises a first portion, the profile of which follows the shape of the fixed turbine engine portion facing the flange.

7. The device according to claim 1, wherein the screen comprises an inner edge and an outer edge, the screen being attached to the flange by attachment means positioned at one of the edges, the other edge being free.

8. The device according to claim 7, wherein the screen is attached to the flange at a secured connection between the flange and the fixed turbine engine portion.

9. The device according to claim 7, wherein the attachment means comprise at least one elastic element laid out for at least partly absorbing the stresses associated with expansion of the screen.

10. The device according to claim 1, wherein the screen is folded at a free edge so as to have a fold adapted for stiffening the screen.

11. A turbine engine turbine comprising a device according to claim 1.

12. A turbine engine comprising a device according to claim 1.
